(19) United States
(12) Patent Application Publication
(10) Pub. No.: US 2025/0076534 A1
(43) Pub. Date: Mar. 6, 2025

(54) CALIBRATION METHOD, APPARATUS AND SYSTEM OF LOOK-AHEAD LOGGING-WHILE-DRILLING MEASURING DEVICE

(71) Applicant: INSTITUTE OF GEOLOGY AND GEOPHYSICS, CHINESE ACADEMY OF SCIENCES, Beijing (CN)

(72) Inventors: Ranming LIU, Beijing (CN); Wenxiu ZHANG, Beijing (CN); Wenxuan CHEN, Beijing (CN); Xinghan LI, Beijing (CN); Pengfei LIANG, Beijing (CN)

(73) Assignee: INSTITUTE OF GEOLOGY AND GEOPHYSICS, CHINESE ACADEMY OF SCIENCES, Beijing (CN)

(21) Appl. No.: 18/774,529

(22) Filed: Jul. 16, 2024

(30) Foreign Application Priority Data
Sep. 6, 2023 (CN) 202311146181.4

(51) Int. Cl. G01V 13/00

(52) U.S. Cl. CPC G01V 13/00; G01V 2200/16

(57) ABSTRACT

Disclosed are a calibration method, an apparatus and a system of a look-ahead logging while drilling measuring device. The calibration method includes: setting the distance from the look-ahead logging while drilling measuring device to a reflective interface as a first preset distance, and measuring the amplitude and phase of a signal received at the distance to obtain a first standard blank data; descending the look-ahead logging while drilling measuring device by a second preset distance a plurality of times, and measuring the amplitude and phase of the received signal after each descent of the second preset distance, respectively to obtain measurement results; re-setting the distance from the look-ahead logging while drilling measuring device to the reflective interface as the first preset distance, and measuring the amplitude and phase of a signal received at the distance to obtain a second standard blank data.

### CROSS-REFERENCE TO RELATED APPLICATIONS

This application claims priority to Chinese Patent Application No. 202311146181.4, filed on Sep. 6, 2023, the content of which is incorporated herein by reference in its entirety.

### TECHNICAL FIELD

The present disclosure belongs to the technical field of structural detection and, more particularly, relates to a calibration method, an apparatus and a system of a look-ahead logging while drilling measuring device.

### BACKGROUND

At present, the electromagnetic wave logging-while-drilling technology only can measure radial detection depth, which is the look around distance. When the angle between the formation interface and the instrument increases, the formation information contained in the detection results decreases gradually. The experimental results show that when the well inclination angle α is about 55°, the look-ahead detection capability will be greatly reduced with the decrease of the well inclination angle, and even for the instrument with the longest detection distance, the look-ahead detection signal is almost zero when the well inclination angle is less than 50°. Therefore, only relying on radial detection means is still limited by geological conditions, and does not have universality. The inability to keep the bit in the target layer at all times does not fulfill the need for drilling measurements. The look-ahead logging while drilling electromagnetic wave resistivity instrument has the ability to detect more than ten meters ahead of the bit from a physical point of view, greatly improving the accuracy of determining the characteristics of structures and reservoirs, thereby improving the drilling encounter rate, drilling success rate, and recovery rate of oil layers. At present, the calibration methods of the look-ahead logging while drilling electromagnetic wave resistivity instruments are relatively few at home and abroad. A traditional method is to use a water tank for calibration, but the electromagnetic wave instrument is long, and it is unrealistic to establish a tens of meters long water tank test environment. The other is to refer to the calibration method of the azimuth electromagnetic propagation logging while drilling tool, which is based on the air-seawater double-layer medium reflective surface for testing. Seawater is a kind of good conductor, and the wide seawater surface can satisfy the interface conditions, and the uniform medium property of seawater also simplifies the numerical calculation model and ensures the consistency between the forward model and the measurement environment.

The look-ahead logging while drilling electromagnetic wave resistivity instrument is used to measure the formation information ahead of the bit, while the azimuthal-while-drilling electromagnetic wave resistivity instrument is mainly used to measure the formation around the well, so it is not possible to directly adopt the calibration process of the azimuthal electromagnetic wave instrument. On the other hand, the calibration of look-ahead instruments cannot be done directly using the same test conditions as for azimuthal electromagnetic wave instruments. Because the look-ahead instruments have a much larger detection range, the metal arms used in the calibration process, as well as the sludge on the seabed, are all within the detection range and can affect the received signals. Therefore, for the calibration of the look-ahead instrument, it is necessary to eliminate the influence of the metal arm and compare the simulation results of the three-layer model and the double-layer model to further analyze the test results.

### SUMMARY

It is an objective of the present disclosure to provide a calibration method, an apparatus and a system of a look-ahead logging while drilling measuring device that addresses at least one of the technical problems mentioned above. The specific solutions are as follows.

To address the above problems, in one aspect of the present disclosure, provided is a calibration method of a look-ahead logging while drilling measuring device, the calibration method including: hoisting the look-ahead logging while drilling measuring device vertically; setting the distance from the look-ahead logging while drilling measuring device to a reflective interface as a first preset distance, and measuring the amplitude and phase of a signal received at the distance to obtain a first standard blank data; descending the look-ahead logging while drilling measuring device by a second preset distance a plurality of times, and measuring the amplitude and phase of the received signal after each descent of the second preset distance, respectively to obtain measurement results; re-setting the distance from the look-ahead logging while drilling measuring device to the reflective interface as the first preset distance, and measuring the amplitude and phase of a signal received at the distance to obtain a second standard blank data; and calculating a correction factor based on the first standard blank data, the measurement results, and the second standard blank data.

In an alternative embodiment, the first preset distance is 30 m; and the second preset distance is 1 m.

In an alternative embodiment, the reflective medium is seawater, and the reflective interface is the sea surface; or the reflective medium is salt-soaked soil, wherein the surface of the salt-soaked soil is covered with an iron plate, and the reflective interface is a side of the iron plate close to the look-ahead logging while drilling measuring device.

In an alternative embodiment, a minimum distance of projection of the look-ahead logging while drilling measuring device on the reflective interface to a boundary of the reflective interface is greater than 35 m.

In an alternative embodiment, the look-ahead logging while drilling measuring device includes: a transmitter configured to transmit a signal; a first receiver configured to receive the signal; a second receiver located at one end of the first receiver remote from the transmitter and configured to receive the signal; wherein the transmitter is close to the reflective interface and the second receiver is away from the reflective interface when the look-ahead logging while drilling measuring device is hoisted vertically.

In an alternative embodiment, the transmitter is configured to transmit signals at frequencies of 5 kHz and 20 kHz.

In an alternative embodiment, the first preset distance is the straight-line distance from the transmitter to the reflective interface.

In an alternative embodiment, in each measurement of the amplitude and phase of the received signal, the resistivity of the reflective medium is simultaneously measured to obtain comparison data; wherein the comparison data is configured to perform a simulation calculation.

In an alternative embodiment, the calibration method of the look-ahead logging while drilling measuring device further includes: dividing the first standard blank data, the measurement results and the second standard blank data into real parts and imaginary parts; and dividing the comparison data into a real part and an imaginary part.

In an alternative embodiment, calculating the correction factor based on the first standard blank data, the measurement results, and the second standard blank data includes:

$${A}_{coe} = \sqrt{{Re}^{2} + I {m}^{2}}$$

Wherein,

$$Re = \frac{{R}^{⋆} R + {I}^{⋆} I}{{R}^{2} + {I}^{2}} and I m = \frac{{I}^{⋆} R - {R}^{*} I}{{R}^{2} + {I}^{2}} ;$$

R* and I* represent the real and imaginary parts of the simulation calculation, respectively; R and I represent the real and the imaginary parts of the measurement data, respectively; and A_{coe} represents a correction coefficient of the measured signal; and the measurement data include the first standard blank data, the measurement results, and the second standard blank data.

According to another aspect of the present disclosure, provided is a calibration apparatus of a look-ahead logging while drilling measuring device, the calibration apparatus being configured to perform the calibration method of any one of the solutions described above.

According to yet another aspect of the present disclosure, provided is a calibration system of a look-ahead logging while drilling measuring device, including a calibration apparatus of any one of the preceding solutions and a look-ahead logging while drilling measuring device to be calibrated.

The above-mentioned technical solutions in the present disclosure have the following advantageous technical effects:

By the calibration method of the look-ahead logging while drilling measuring device, a hoist distance from the look-ahead logging while drilling measuring device to the reflective interface can be determined by setting the first preset distance, and a correction factor can be calculated based on the first standard blank data, the measurement results, and the second standard blank data. The correction factor obtained by the calibration method of the look-ahead logging while drilling measuring device of the present disclosure substantially reduces the influence of the surrounding environment, enhances the signal intensity, and also substantially improves the accuracy of the calibration by measuring at different heights.

### BRIEF DESCRIPTION OF THE DRAWINGS

FIG. 1 shows a flow diagram of a calibration method of a look-ahead logging while drilling measuring device according to an embodiment of the present disclosure.

FIG. 2 shows a schematic diagram of a calibration system of a look-ahead logging while drilling measuring device according to an embodiment of the present disclosure.

FIG. 3 shows a graph of the influence of a metal arm on a received signal.

FIG. 4 shows a schematic diagram of a double-layer model and a three-layer model, in which (a) represents an air-seawater double-layer model and (b) represents an air-seawater-sludge three-layer model.

FIG. 5 shows a schematic diagram comparing the calculation results of 10 m-5 kHz seawater with different depths versus a double-layer model.

FIG. 6 shows a schematic diagram of the influence of the look-ahead logging while drilling measuring device on the amplitude ratio signal, wherein (a) represents the 2-layer model used for the simulation calculation, (b) represents the attenuation of the axial signal component, and (c) represents the attenuation of the horizontal signal component.

FIG. 7 shows a graphical representation of signal response comparisons of air-seawater models versus a standard model in accordance with an embodiment of the present disclosure, wherein (a) represents signal response comparison of a 5 kHz-short-spacing air-seawater model versus the standard model; (b) represents the signal response comparison of a 20 kHz-short-spacing air-seawater model versus the standard model; (c) represents the signal response comparison of a 5 kHz-long-spacing air-seawater model versus the standard model; and (d) represents the signal response comparison of a 20 kHz-long-spacing air-seawater model versus the standard model. The dashed line in the figure shows the signal intensity for the 100 Ω·m-1 Ω·m model, and the solid line shows the signal intensity for the air-seawater model.

### DETAILED DESCRIPTION OF THE EMBODIMENTS

In order to make the objective, technical solution, and advantages of the present disclosure clearer, the following is a detailed explanation of the present disclosure, combined with specific examples and referring to the accompanying drawings. It is to be understood that this description is made only by way of example and not as a limitation on the scope of the present disclosure. Further, in the following description, descriptions of publicly known structures and techniques are omitted to avoid unnecessarily confusing the concepts of the present disclosure.

A schematic diagram of a layer structure according to an embodiment of the present disclosure is shown in the accompanying drawings. These drawings are not to scale, in which certain details have been enlarged for the purpose of clarity, and certain details may have been omitted. The shapes of the various regions and layers as well as the relative sizes and positional relationships among them shown in the drawings are only exemplary and may be deviated from in practice due to manufacturing tolerances or technical limitations, and the person skilled in the art may additionally design regions/layers having different shapes, sizes, and relative positions according to actual requirements.

Obviously, the described embodiments are a part of the embodiments of the present disclosure and not all of the embodiments. Based on the embodiments of the present disclosure, all other embodiments obtained by a person of ordinary skill in the art without inventive effort fall within the scope of the present disclosure.

In addition, the technical features involved in the different embodiments of the present disclosure described below can be combined with each other as long as they do not conflict with each other.

The present disclosure will be described in more detail below with reference to the accompanying drawings. In the various accompanying drawings, identical components are represented using similar accompanying symbols. For the sake of clarity, parts of the accompanying drawings are not drawn in scale.

Of the related technologies, the Irisphere, and BrightStar instruments were launched in 2019 and 2021, and both are commercially available. No other products of this type have been seen in the industry to date. Both instruments are capable of detecting horizontal and vertical resistivities within up to 100 feet (30 meters) ahead of the bit, as well as the dip and azimuth of the formation, in real-time drilling. In 2019, an antenna utilizing a half-coil structure with both magnetic and electric dipoles was proposed to be able to be used for formation boundary detection ahead of and around the bit, but it is still in the theoretical research stage. The applicant has developed a look-ahead logging while drilling electromagnetic wave resistivity instrument, which adopts a three-component antenna structure. Compared with the azimuthal electromagnetic wave instrument, the transmitting-receiving distances have been increased and the transmitting frequency has been lowered, and is capable of obtaining richer formation information and a wider detection range. The measurement results of look-ahead instruments (look-ahead logging while drilling measuring device) are related to the test environment, electronic devices, temperature drift and other factors, and need to be calibrated before they have physical meaning, and can be further used for the evaluation of detection capability and subsequent inversion calculations.

The present disclosure provides a calibration method, an apparatus and a system of a look-ahead logging while drilling measuring device. The calibration method may include: hoisting the look-ahead logging while drilling measuring device vertically; setting the distance from the look-ahead logging while drilling measuring device to a reflective interface as a first preset distance, and measuring the amplitude and phase of a signal received at the distance to obtain a first standard blank data; descending the look-ahead logging while drilling measuring device by a second preset distance a plurality of times, and measuring the amplitude and phase of the received signal after each descent of the second preset distance, respectively to obtain measurement results; re-setting the distance from the look-ahead logging while drilling measuring device to the reflective interface as the first preset distance, and measuring the amplitude and phase of a signal received at the distance to obtain a second standard blank data; and calculating a correction factor based on the first standard blank data, the measurement results, and the second standard blank data. By the calibration method of the look-ahead logging while drilling measuring device, proposed, to address the shortcomings of the calibration solution that the hoisting test conditions cannot be adapted to the test of the look-ahead instrument, is to set the conditions of the distance between the hoisting point and the shoreside and the depth of the seawater, ensuring that the received signals of the look-ahead instrument are not affected by the metal arm 100 and the sludge on the seabed. Also proposed is the vertical hoisting test flow and data processing method of the look-ahead logging while drilling instrument Based on the air-seawater as the reflective interface. By the calibration method of the look-ahead logging while drilling measuring device, a hoist distance from the look-ahead logging while drilling measuring device to the reflective interface is determined by setting the first preset distance, and a correction factor is calculated based on the first standard blank data, the measurement results, and the second standard blank data. The correction factor obtained by the calibration method of the look-ahead logging while drilling measuring device of the present disclosure substantially reduces the influence of the surrounding environment, enhances the signal intensity, and also substantially improves the accuracy of the calibration by measuring at different heights.

Hereinafter, alternative embodiments of the present disclosure will be described in detail with reference to the accompanying drawings.

According to a specific embodiment of the present disclosure, in one aspect, provided is calibration method of a look-ahead logging while drilling measuring device that may include: hoisting the look-ahead logging while drilling measuring device vertically; setting the distance from the look-ahead logging while drilling measuring device to a reflective interface as a first preset distance, and measuring the resistivity of the reflective medium to obtain the first standard blank data; descending the look-ahead logging while drilling measuring device by a second preset distance a plurality of times, and respectively measuring the resistivity of the reflective medium after each descent of the second preset distance each time to obtain a measurement result; re-setting the distance from the look-ahead logging while drilling measuring device to the reflective interface as the first preset distance, and measuring the resistivity of the reflective medium to obtain a second standard blank data; and calculating a correction factor based on the first standard blank data, the measurement results, and the second standard blank data. By the calibration method of the look-ahead logging while drilling measuring device, a hoist distance from the look-ahead logging while drilling measuring device to the reflective interface is determined by setting the first preset distance, and a correction factor is calculated based on the first standard blank data, the measurement results, and the second standard blank data. The correction factor obtained by the calibration method of the look-ahead logging while drilling measuring device of the present disclosure substantially reduces the influence of the surrounding environment, enhances the signal intensity, and also substantially improves the accuracy of the calibration by measuring at different heights. With respect to the influence of the metal arm 100 and the sludge on the seabed in the test model, based on the numerical simulation calculation of the finite element method, the present disclosure provides the distance from the instrument to the shoreside during the hoisting process, as well as the test conditions that can be approximated from a three-layer model (air-seawater-sludge) to a double-layer model (air-seawater), which is consistent with theoretical model for evaluating the detection capability of the look-ahead instrument and enables the test results to be more accurate and meaningful. The present disclosure provides a calibration procedure and data processing method for the detection capability of look-ahead instruments.

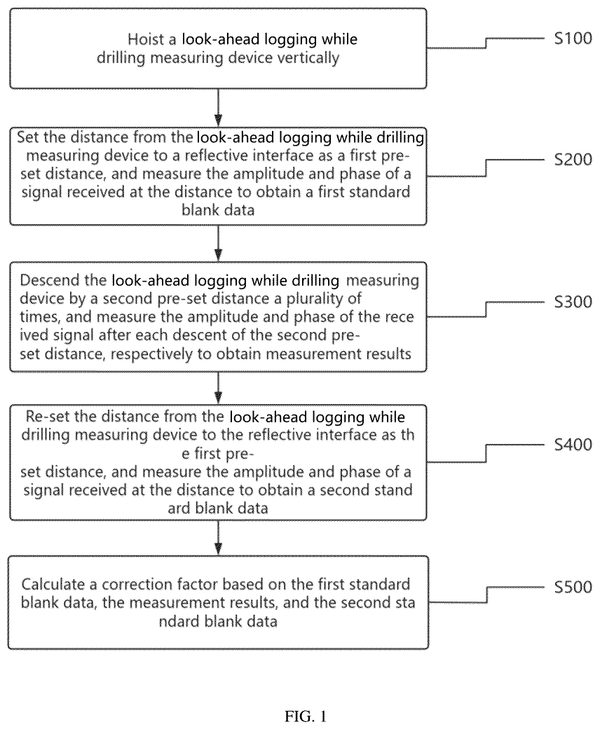

FIG. 1 shows a flow diagram of a calibration method of a look-ahead logging while drilling measuring device according to an embodiment of the present disclosure.

As shown in FIG. 1, the present disclosure provides a calibration method of a look-ahead logging while drilling measuring device that may include at least the following steps:
S100, hoisting the look-ahead logging while drilling measuring device vertically.
S200, setting the distance from the look-ahead logging while drilling measuring device to a reflective interface as a first preset distance, and measuring the amplitude and phase of a signal received at the distance to obtain a first standard blank data.
S300, descending the look-ahead logging while drilling measuring device by a second preset distance a plurality of times, and measuring the amplitude and phase of the received signal after each descent of the second preset distance, respectively to obtain measurement results.
S400, re-setting the distance from the look-ahead logging while drilling measuring device to the reflective interface as the first preset distance, and measuring the amplitude and phase of a signal received at the distance to obtain a second standard blank data.
S500, calculating a correction factor based on the first standard blank data, the measurement results, and the second standard blank data.

In step S100, a metal arm 100 is employed to hoist the look-ahead logging while drilling measuring device vertically from the reflective interface. The reflective interface is the sea surface or an iron plate covered on salt-soaked soil. In order to eliminate the influence of the metal arm 100 on the measurement results, the metal arm 100 is at least 35 m away from the projection of the look-ahead logging while drilling measuring device on the reflective interface. For a 20 kHz transmitting frequency, the metal arm 100 has almost no effect on the received signal when the distance is greater than 32 m, while for a 5 kHz transmitting frequency, a distance of about 35 m is required to ensure that the received signal is not affected by the metal arm 100. Therefore, in the actual testing process, it is needed to ensure that the distance is greater than 35 m. According to the relationship between the hoisting height and the distance, this condition can meet the requirements of the testing environment while ensuring security. This distance is greater than 35 meters, eliminating the metal arm 100 from having an effect on the received signal, nor will it have an effect during the descent of the look-ahead logging while drilling measuring device.

In step S200, the upper layer of the reflective interface is high-resistivity air, the middle layer is seawater, and the last layer is sludge. Since the test environment is a three-layer model, and the look-ahead detection range is determined through the calculation of the double-layer model, by comparing the consistency of the calculation results of the two models, the approximate conditions of the test model and theoretical model can be determined, and the test calibration results are more accurate under the above conditions. In an alternative embodiment, the first preset distance is 30 m.

In step S300, the amplitude and phase of the look-ahead logging while drilling measuring device are respectively measured at heights of 30 m, 29 m, 28 m, 27 m, 26 m, 25 m, 24 m, 23 m, 22 m, 21 m, 20 m, 19 m, 18 m, 17 m, 16 m, 15 m, 14 m, 13 m, 12 m, 11 m, 10 m, 9 m, 8 m, 7 m, 6 m, 5 m, 4 m, 3 m, 2 m, and 1 m. Data can be collected at each height position for a minimum of 180 seconds and the measurement start time can be recorded. In an alternative embodiment, the second preset distance is 1 m.

In step S400, the sea surface test requires selecting a harbor environment with a suitable seawater depth. The reasons for selecting a harbor include, first, seawater can be viewed as a good conductor, with a high resistivity contrast to air, and a larger signal response can be obtained as a means of suppressing the effect of ambient noise. In addition, the air-seawater model used in the harbor test is simple, which is conducive to forward simulation, and the test results can be easily compared with the numerical simulation results. The specific test flow is as follows: the seawater resistivity was measured once at intervals. Two times of collecting the standard blank data (namely, the first standard blank data and the second standard blank data) are used for data processing on the one hand and are used for evaluating the quality of the test data on the other hand. This is because excessive wind and waves in the test environment can cause the instrument to oscillate and also cause the sea surface height to change, making it difficult to pick data during data processing and causing an error between the test results and the expected results.

Step S500 may include S510, in each measurement of the amplitude and phase of the received signal, simultaneously measuring the resistivity of the reflective medium to obtain comparison data; wherein the comparison data is configured to perform a simulation calculation; and S520, dividing the first standard blank data, the measurement results and the second standard blank data into real parts and imaginary parts. Specifically, in step S500, all the measured values of the instrument are absolute voltage signals, and the response values thereof are related to many factors and are inconsistent with the simulation calculation results. Therefore, the measurement data must be corrected before being used for the evaluation of detection capability and subsequent inversion calculation. The relationship between the measured data and the forward result is established through the correction coefficient, and the calculation formula of the correction coefficient is given below:

$${A}_{coe} = \sqrt{{Re}^{2} + I {m}^{2}}$$

Wherein,

$$Re = \frac{{R}^{⋆} R + {I}^{⋆} I}{{R}^{2} + {I}^{2}} and I m = \frac{{I}^{⋆} R - {R}^{*} I}{{R}^{2} + {I}^{2}} ,$$

R* and I* represent the real and imaginary parts of the simulation calculation, respectively; R and I represent the real and the imaginary parts of the measurement data, respectively; and A_{coe} represents a correction coefficient of the measured signal. Since the transmitting and receiving antennas are wound around the drill collar in the form of coils, the conductivity of the drill collar is typically 10⁶-10⁷ S/m, much higher than the conductivity of the formation. Therefore, the metal drill collar can significantly attenuate the signal. When the received signal intensity is close to the noise level, the voltage signal is usually distorted and does not accurately show the influence pattern of the layer interface. The amplitude ratio signal is thus defined as:

$${A}_{tt} = 20 log \frac{{V}_{TR 1}}{{V}_{TR 2}}$$

Wherein, V_{TR1} is the received signal intensity at a short spacing, and V_{TR2} is the received signal intensity at a long spacing. The correction factor is calculated based on the first standard blank data, the measurement results, and the second standard blank data.

Step S520 may include:
S521, determining whether the standard deviation of the standard data (the standard deviation of the absolute voltage signal is less than 0.001) meets the requirements.
S522, deleting the first and last data of each channel, and calculating the average value of the remaining data as the absolute voltage signal at the measurement point.
S523, correcting the measurement data by the correction coefficient.
S524, calculating the amplitude ratio signal according to the corrected result, and obtaining the detection depth of the measurement model through the minimum resolution of the instrument.
S525, converting the detection depth of the measurement model to a detection depth of a 100 Ω·-1 Ω·standard model.

In some embodiments, the first preset distance is 30 m; and the second preset distance is 1 m.

In some embodiments, the reflective medium is seawater, and the reflective interface is the sea surface; or the reflective medium is salt-soaked soil, wherein the surface of the salt-soaked soil is covered with an iron plate, and the reflective interface is a side of the iron plate close to the look-ahead logging while drilling measuring device. The sea surface test requires selecting a harbor environment with a suitable seawater depth. The reasons for selecting a harbor include, first, seawater can be viewed as a good conductor, with a high resistivity contrast to air, and a larger signal response can be obtained as a means of suppressing the effect of ambient noise. In addition, the air-seawater model used in the harbor test is simple and is conducive to forward simulation. The test results can be easily compared with the numerical simulation results. If no suitable sea testing environment can be found, an open testing environment can also be selected on the ground. A large enough iron plate is laid as a good conductor reflective interface, and the soil below the iron plate is poured with salt water to reduce the resistivity, approximately simulating a double-layer testing model. At the same time, it is necessary to ensure the test environment conditions, and the test flow and data processing method thereof are consistent with those in the air-seawater scheme described above.

In some embodiments, a minimum distance of projection of the look-ahead logging while drilling measuring device on the reflective interface to a boundary of the reflective interface is greater than 35 m.

In some embodiments, the look-ahead logging while drilling measuring device may include: a transmitter 200 configured to transmit a signal; a first receiver 300 configured to receive the signal; a second receiver 400 located at one end of the first receiver 300 remote from the transmitter 200 and configured to receive the signal; wherein the transmitter 200 is close to the reflective interface and the second receiver 400 is away from the reflective interface when the look-ahead logging while drilling measuring device is hoisted vertically.

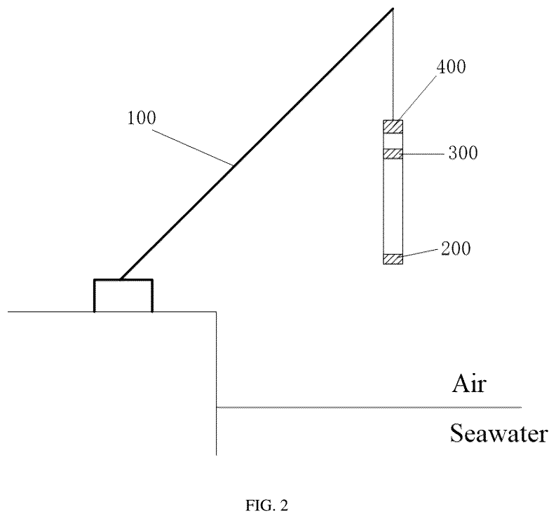

FIG. 2 shows a schematic diagram of a calibration system of a look-ahead logging while drilling measuring device according to an embodiment of the present disclosure.

As shown in FIG. 2, the antenna structure of the look-ahead logging while drilling electromagnetic wave resistivity instrument is as shown in FIG. 2, wherein T represents a transmitting antenna (i.e. a transmitter 200), and R1 (i.e. a first receiver 300) and R2 (i.e. a second receiver 400) are respectively receiving antennas, and each antenna contains three components, x, y, and z. A three-dimensional model is established by using COMSOL three-dimensional finite element software, and the test model described below is adopted. The tail end of the metal arm 100 is on the shoreside, and the perpendicular distance from the highest hoisting point to the receiving antenna is 30 m. If the metal arm 100 at the highest vertical hoisting point of the instrument does not have an influence on the received signal, it will also have no influence during the descent process of the instrument position.

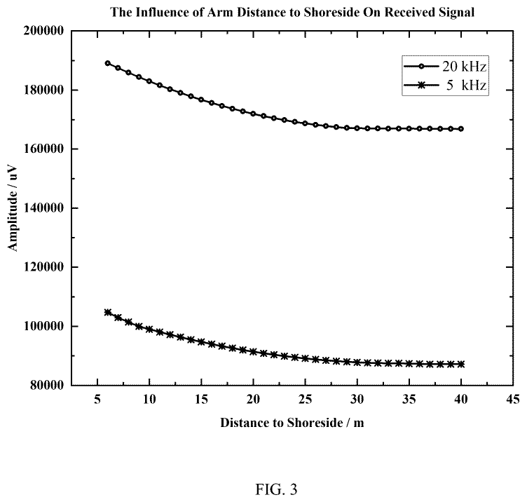

FIG. 3 shows a graph of the influence of a metal arm on a received signal.

As shown in FIG. 3, in the double-layer air-seawater model without the metal arm 100, the received signal intensities at the transmitting frequencies of 5 and 20 kHz are calculated respectively, and the calculation results are compared with the calculation results of the model with the metal arm 100. As can be seen from FIG. 3, For a 20 kHz transmitting frequency, the metal arm has almost no effect on the received signal when D is greater than 32 m, while for a 5 kHz transmitting frequency, a distance of about 35 m is required to ensure that the received signal is not affected by the metal arm. Therefore, in the actual testing process, it is needed to ensure that D is greater than 35 m. According to the relationship between the hoisting height and D, this condition can meet the requirements of the testing environment

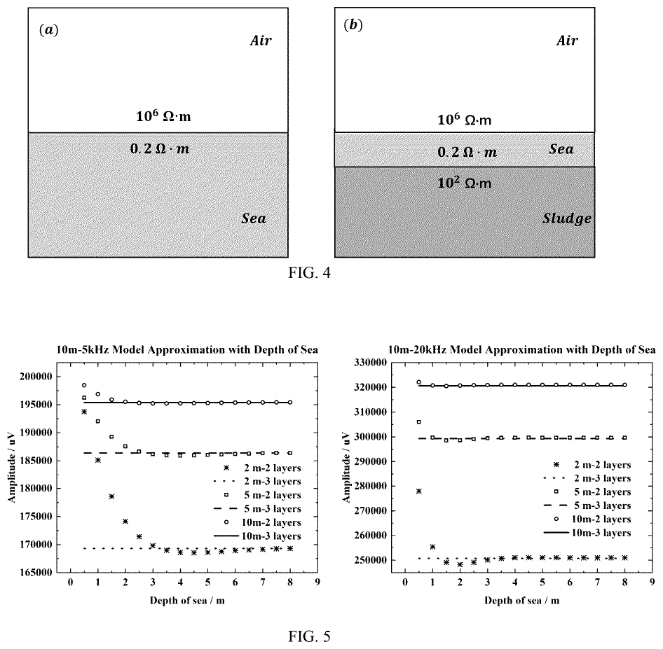

FIG. 4 shows a schematic diagram of a double-layer model and a three-layer model, in which (a) represents an air-seawater double-layer model and (b) represents an air-seawater-sludge three-layer model.

As shown in FIG. 4, which shows a schematic diagram of the air-seawater double-layer model and the air-seawater-sludge three-layer model, respectively. The first layer in the three-layer model is air with a high resistivity, the middle layer is seawater with a resistivity of 0.2 Ω·, and the last layer is sludge with a resistivity of 100 Ω·. Since the test environment is a three-layer model, and the look-ahead detection range is determined through the calculation of the double-layer model, by comparing the consistency of the calculation results of the two models, the approximate conditions of the test model and the theoretical model can be determined, and the test calibration results can be more accurate under the above conditions.

FIG. 5 shows a schematic diagram comparing the calculation results of 10 m-5 kHz seawater with different depths with a double-layer model.

As shown in FIG. 5, the received signal intensities at different distances from the axial antenna to the sea surface (Transmitter to boundary(TTB)), 2 m, 5 m and 10 m, respectively, are compared with the results of the double-layer model. The figure below shows that when the instrument is away from the sea surface, the received signal is less affected by the depth of the middle layer. For 5 kHz transmitting frequency, when TTB=2 m, the seawater depth needs to be more than 6 m to ensure the model approximation, while when TTB=10 m, the seawater depth of 2 m can achieve the approximation requirements.

Other spacings are analyzed in the same manner as described above, and Table 1 lists the approximate conditions to be met for each spacing and transmitting frequency condition. It can be seen from Table 1 that the approximate conditions of these sets of spacings are basically the same, and a good approximate result can be obtained when the seawater depth reaches 7 m under a more severe approximation standard. Therefore, the influence of local fluctuation tide on seawater depth should be considered when selecting experimental sites.

TABLE 1
Approximate conditions for different spacings and transmitting
frequency combinations at different TTB positions

| | Spacing | | | | | | | |
|---|---|---|---|---|---|---|---|---|
| | 10 m | | 12 m | | 14 m | | 17 m | |
| | Transmitting frequency | | | | | | | |
| | 5 | 20 | 5 | 20 | 5 | 20 | 5 | 20 |
| | kHz | kHz | kHz | kHz | kHz | kHz | kHz | kHz |
| TTB = 2 m | 7.0 m | 3.5 m | 7.0 m | 3.5 m | 7.0 m | 3.5 m | 7.0 m | 3.5 m |
| TTB = 5 m | 6.0 m | 3.0 m | 6.0 m | 3.0 m | 6.5 m | 3.5 m | 6.5 m | 3.5 m |
| TTB = 10 m | 2.0 m | 2.0 m | 2.0 m | 1.0 m | 2.0 m | 3.0 m | 2.0 m | 2.5 m |

In some embodiments, the transmitter 200 is configured to transmit signals at frequencies of 5 kHz and 20 kHz.

In some alternative embodiments, the first preset distance is the straight-line distance from the transmitter 200 to the reflective interface.TTB

In some alternative embodiment, calculating a correction factor based on the first standard blank data, the measurement results, and the second standard blank data may include:

$${A}_{coe} = \sqrt{{Re}^{2} + I {m}^{2}}$$

Wherein,

$$Re = \frac{{R}^{⋆} R + {I}^{⋆} I}{{R}^{2} + {I}^{2}} and I m = \frac{{I}^{⋆} R - {R}^{*} I}{{R}^{2} + {I}^{2}} ;$$

R* and I* represent the real part and imaginary part obtained by simulation, respectively; R and I represent the real and the imaginary parts of the measurement data, respectively; and A_{coe} represents a correction coefficient of the measured signal; and the measurement data include the first standard blank data, the measurement results, and the second standard blank data.

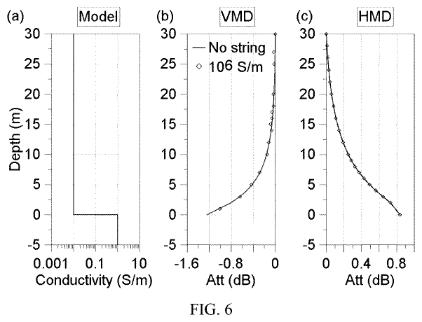

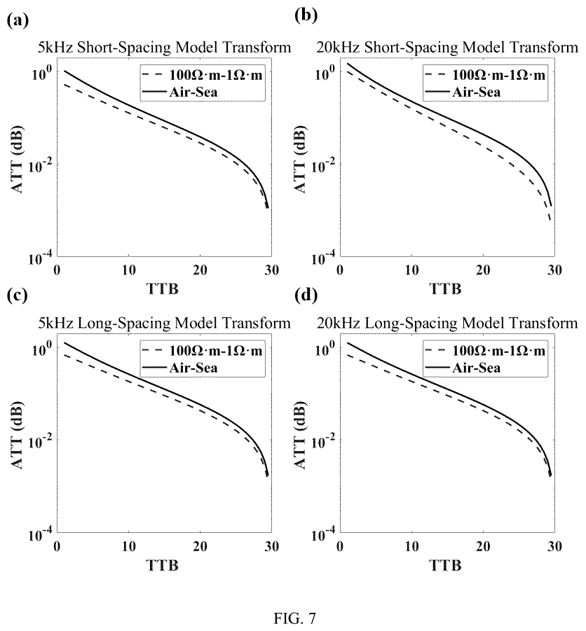

FIG. 6 shows a schematic diagram of the influence of the look-ahead logging while drilling measuring device on the amplitude ratio signal, wherein (a) represents the 2-layer model used for the numerical simulation, (b) represents the attenuation of the axial signal component, and (c) represents the attenuation of the horizontal signal component. FIG. 7 shows a graphical representation of signal response comparisons of air-seawater models versus a standard model signal in accordance with an embodiment of the present disclosure, wherein (a) represents signal response comparison of a 5 kHz-short-spacing air-seawater model versus the standard model; (b) represents the signal response comparison of a 20 kHz-short-spacing air-seawater model versus the standard model; (c) represents the signal response comparison of a 5 kHz-long-spacing air-seawater model versus the standard model; and (d) represents the signal response comparison of a 20 kHz-long-spacing air-seawater model versus the standard model. The dashed line in the figure shows the signal intensity for the 100 Ω·-1 Ω·model, and the solid line shows the signal intensity for the air-seawater model

As shown in FIGS. 6 and 7, the presence of the look-ahead logging while drilling measuring device does not change the signal attenuation curve of the amplitude ratio. The measurement result of the hoist point is taken as the voltage signal of the uniform space, and the amplitude ratio signal of each measuring point minus the amplitude ratio of the uniform space is taken as the evaluation index of look-ahead detection capability. 0.05 dB is taken as the minimum resolution of the instrument, and the detection capability of the look-ahead instrument is defined according to the standard that the absolute voltage value is greater than 100 nV. In general, instrument detectability refers to the ability of an instrument to detect a 1 Ω·formation in a 100 Ω·formation. Therefore, it is necessary to convert the detection depth of measurement model to the standard 100 Ω·-1 Ω·model. The signal intensity of the air-seawater model and 100 Ω·-1 Ω·model is shown in FIG. 7. Through comparison and conversion, the detection range of the look-ahead instrument in the 100 Ω·-1 Ω·formation model can be given.

According to a specific implementation of the present disclosure, on the other hand, provided is a calibration apparatus of a look-ahead logging while drilling measuring device, the calibration apparatus being configured to perform a calibration method of any one of the solutions described above.

According to a specific implementation of the present disclosure, on the yet another hand, provided is a calibration system of a look-ahead logging while drilling measuring device, including a calibration apparatus of any one of the preceding solutions and a look-ahead logging while drilling measuring device to be calibrated.

The present disclosure aims to claim a calibration method, an apparatus, and a system of a look-ahead logging while drilling measuring device, the calibration method may include: hoisting the look-ahead logging while drilling measuring device vertically; setting the distance from the look-ahead logging while drilling measuring device to a reflective interface as a first preset distance, and measuring the amplitude and phase of a signal received at the distance to obtain a first standard blank data; descending the look-ahead logging while drilling measuring device by a second preset distance a plurality of times, and measuring the amplitude and phase of the received signal after each descent of the second preset distance, respectively to obtain measurement results; re-setting the distance from the look-ahead logging while drilling measuring device to the reflective interface as the first preset distance, and measuring the amplitude and phase of a signal received at the distance to obtain a second standard blank data; and calculating a correction factor based on the first standard blank data, the measurement results, and the second standard blank data. By the calibration method of the look-ahead logging while drilling measuring device, a hoist distance from the look-ahead logging while drilling measuring device to the reflective interface is determined by setting the first preset distance, and the correction factor is calculated based on the first standard blank data, the measurement results, and the second standard blank data. The correction factor obtained by the calibration method of the look-ahead logging while drilling measuring device of the present disclosure substantially reduces the influence of the surrounding environment, enhances the signal intensity, and also substantially improves the accuracy of the calibration by measuring at different heights.

It is to be understood that the above-described specific implementations of the disclosure are merely illustrative or explanatory of the principles of the disclosure and are not restrictive of the disclosure. Therefore, any modifications, equivalent replacements, improvements, etc. made without deviating from the spirit and scope of this disclosure shall be included within the scope of the present disclosure. Furthermore, it is intended that the appended claims cover all such variations and modifications that fall within the scope and boundaries of the appended claims or equivalent forms of such scope and boundaries.

What is claimed is:

1. A calibration method of a look-ahead logging while drilling measuring device, comprising:
hoisting the look-ahead logging while drilling measuring device vertically;
setting a distance from the look-ahead logging while drilling measuring device to a reflective interface as a first preset distance, and measuring an amplitude and phase of a signal received at the distance to obtain a first standard blank data;
descending the look-ahead logging while drilling measuring device by a second preset distance a plurality of times, and measuring an amplitude and phase of a received signal after each descent of the second preset distance, respectively to obtain measurement results;
re-setting the distance from the look-ahead logging while drilling measuring device to the reflective interface as the first preset distance, and measuring an amplitude and phase of a signal received at the distance to obtain a second standard blank data; and
calculating a correction factor based on the first standard blank data, the measurement results, and the second standard blank data.

2. The calibration method of the look-ahead logging while drilling measuring device of claim 1, wherein
the first preset distance is 30 m; and
the second preset distance is 1 m.

3. The calibration method of the look-ahead logging while drilling measuring device of claim 1, wherein
a reflective medium is seawater, and the reflective interface is the sea surface; or
a reflective medium is salt-soaked soil, wherein a surface of the salt-soaked soil is covered with an iron plate, and the reflective interface is a side of the iron plate close to the look-ahead logging while drilling measuring device.

4. The calibration method of the look-ahead logging while drilling measuring device of claim 1, wherein
a minimum distance of projection of the look-ahead logging while drilling measuring device on the reflective interface to a boundary of the reflective interface is greater than 35 m.

5. The calibration method of the look-ahead logging while drilling measuring device of claim 1, wherein the look-ahead logging while drilling measuring device comprises:
a transmitter configured to transmit a signal;
a first receiver configured to receive the signal;
a second receiver located at one end of the first receiver remote from the transmitter and configured to receive the signal;
wherein the transmitter is close to the reflective interface and the second receiver is away from the reflective interface when the look-ahead logging while drilling measuring device is hoisted vertically.

6. The calibration method of the look-ahead logging while drilling measuring device of claim 5, wherein
the transmitter is configured to transmit signals at frequencies of 5 kHz and 20 kHz.

7. The calibration method of the look-ahead logging while drilling measuring device of claim 5, wherein
the first preset distance is a straight-line distance from the transmitter to the reflective interface.

8. The calibration method of the look-ahead logging while drilling measuring device of claim 1, further comprising:
in each measurement of the amplitude and phase of the received signal, simultaneously measuring a resistivity of the reflective medium to obtain comparison data;
wherein the comparison data is configured to perform a simulation calculation.

9. The calibration method of the look-ahead logging while drilling measuring device of claim 8, further comprising:
dividing the first standard blank data, the measurement results and the second standard blank data into real parts and imaginary parts; and
dividing the comparison data into a real part and an imaginary part.

10. The calibration method of the look-ahead logging while drilling measuring device of claim 9, wherein calculating the correction factor based on the first standard blank data, the measurement results, and the second standard blank data comprises:
$${A}_{coe} = \sqrt{{Re}^{2} + I {m}^{2}}$$
wherein,
$$Re = \frac{{R}^{⋆} R + {I}^{⋆} I}{{R}^{2} + {I}^{2}} and I m = \frac{{I}^{⋆} R - {R}^{*} I}{{R}^{2} + {I}^{2}} ;$$
R* and I* represent the real part and imaginary part of the simulation calculation, respectively; R and I represent the real part and the imaginary part of measurement data, respectively; and A_{coe} represents a correction coefficient of measured signal;
the measurement data comprises the first standard blank data, the measurement results, and the second standard blank data.

11. A calibration apparatus of a look-ahead logging while drilling measuring device, wherein the calibration apparatus is configured to perform the calibration method of claim 1.

12. A calibration system of a look-ahead logging while drilling measuring device, comprising the calibration apparatus of claim 11 and the look-ahead logging while drilling measuring device to be calibrated.
